(19) United States
(12) Patent Application Publication
(10) Pub. No.: US 2018/0253655 A1
(43) Pub. Date: Sep. 6, 2018

(54) SKILLS CLUSTERING WITH LATENT REPRESENTATION OF WORDS

(71) Applicant: Linkedln Corporation, Sunnyvale, CA (US)

(72) Inventors: Qin Iris Wang, Cupertino, CA (US); Siyuan Zhang, Mountain View, CA (US); Mohsen Jamali, Sunnyvale, CA (US); Hamed Firooz, Fremont, CA (US)

(21) Appl. No.: 15/448,290

(22) Filed: Mar. 2, 2017

(51) Int. Cl. G06N 5/04; G06F 17/30

(52) U.S. Cl. CPC G06N 5/04; G06F 17/30958; G06F 17/30283

(57) ABSTRACT

Systems and methods for identifying appropriate course recommendations are disclosed. A system receives a request for recommended courses and accesses a plurality of course records to determine whether a sufficient number of courses that teach the skill of interest are available. In accordance with a determination that a sufficient number of courses that teach the skill of interest are not available, the system generates skill attribute vectors for a skill of interest and a plurality of other skills and ranks the plurality of other skills based on the distance between the skill attribute for the skill of interest and the plurality of other skills. The system selects a skill based on the rankings. The system identifies at least one course that teaches the selected skill and transmits a course recommendation for the identified course to a client system for presentation.

### TECHNICAL FIELD

The disclosed example embodiments relate generally to the field of data analytics and, in particular, to using deep learning techniques to improve data standardization.

### BACKGROUND

The rise of the computer age has resulted in increased access to personalized services online. As the cost of electronics and networking services drops, many services can be provided remotely over the Internet. For example, entertainment has increasingly shifted to the online space with companies such as Netflix and Amazon streaming television shows and movies to members at home. Similarly, electronic mail (e-mail) has reduced the need for letters to be physically delivered. Instead, messages are sent over networked systems almost instantly.

Another service provided over networks is social networking. Large social networks allow members to connect with each other and share information. Social networks generate a large amount of data to be sorted and standardized in order to be useful. One such type of information is information about the skills that members of the server system possess.

### DESCRIPTION OF THE DRAWINGS

Some example embodiments are illustrated by way of example and not limitation in the figures of the accompanying drawings.

FIG. 1 is a network diagram depicting a client-server system that includes various functional components of a social networking system, in accordance with some example embodiments.

FIG. 2 is a block diagram illustrating a client system, in accordance with some example embodiments.

FIG. 3 is a block diagram illustrating a social networking system, in accordance with some example embodiments.

FIG. 4 is a user interface diagram illustrating an example of a user interface or web page that incorporates a list of course recommendations to a member of a social networking system (e.g., the social networking system of FIG. 1).

FIG. 5 is a flow diagram illustrating a method, in accordance with some example embodiments, for using attribute vectors for categorizing skills and using those categorizations to recommend courses to members of a social networking system.

FIGS. 6A-6C is a flow diagram illustrating a method, in accordance with some example embodiments, for clustering skills using deep learning techniques at a social networking system.

FIG. 7 is a block diagram illustrating an architecture of software, which may be installed on any of one or more devices, in accordance with some example embodiments.

FIG. 8 is a block diagram illustrating components of a machine, according to some example embodiments.

Like reference numerals refer to corresponding parts throughout the drawings.

### DETAILED DESCRIPTION

The present disclosure describes methods, systems, and computer program products for reclassifying skills into a plurality of clusters using a deep learning technique. In the following description, for purposes of explanation, numerous specific details are set forth to provide a thorough understanding of the various aspects of different example embodiments. It will be evident, however, to one skilled in the art, that any particular example embodiment may be practiced without all of the specific details and/or with variations, permutations, and combinations of the various features and elements described herein.

In some example embodiments, a social networking system has a plurality of members. Each member has an associated member profile. The member profile for each member includes, among other things, one or more skills that the member has. For example, a member profile might list Hadoop, CSS, and Javascript skills for an associated member. In some example embodiments, skills are explicitly indicated by the member. In other example embodiments, other information in the member history can be parsed to infer member skills (e.g., work history, educational history, and so on)

In some example embodiments, the social networking system uses member skill data for a plurality of uses, including, but not limited to, identifying job listings that would be appropriate for a member, identifying courses that might help a member add to his or her skill list, identifying common skills for a geographic location or educational institution for recruiting purposes, and so on. However, skill data is most useful if it is correctly organized and categorized.

One way to efficiently organize and categorize skills is through the use of deep learning techniques. In some example embodiments, the social networking system stores a list of skill records, each record listing the name of the skill and a description of the skill. In some example embodiments, the social networking system converts a skill record into a skill attribute vector. A skill attribute vector is a series of values that represent the skill in multi-dimensional space.

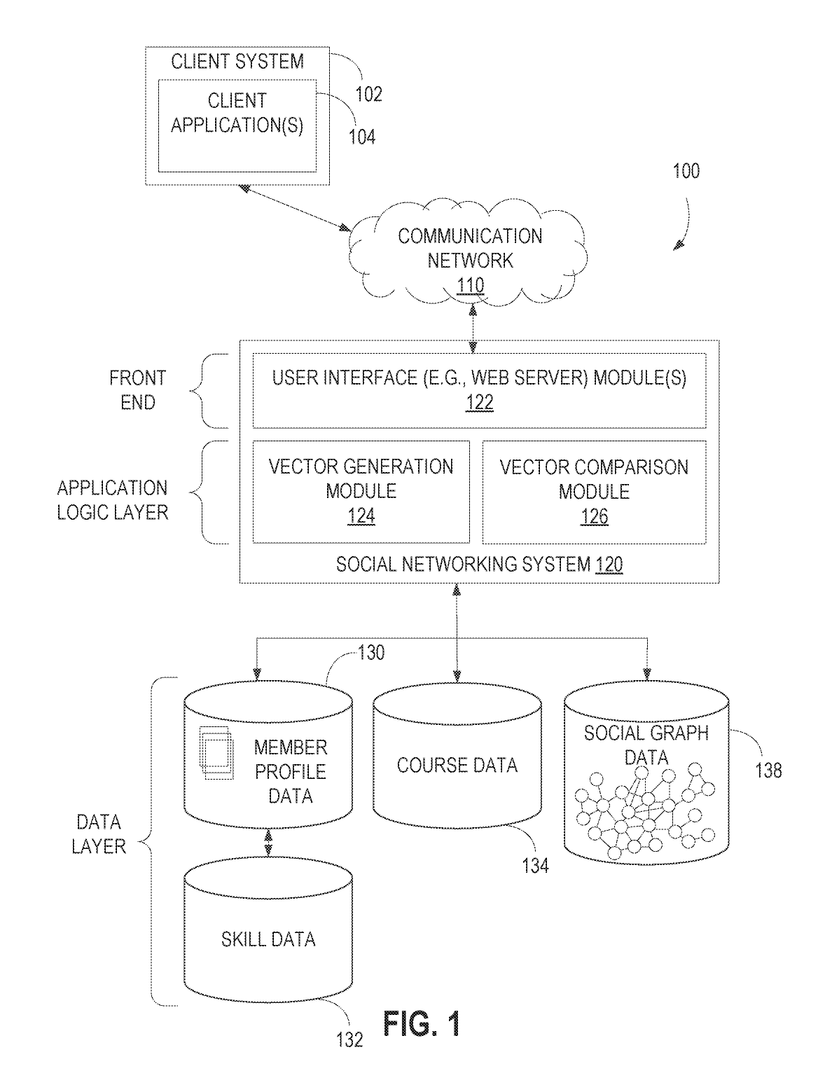

In some example embodiments, the social networking system (e.g., the social networking system 120 in FIG. 1) trains a model using an existing corpus of skills (and skill-related information such as descriptions). Once trained, the model takes a large corpus of text (e.g., a list of skills and descriptions) and produces a vector space that represents the entire corpus. Then, each skill is assigned a vector that represents its place in the vector space.

Once skills have been represented in vector space, the social networking system (e.g., the social networking system 120 in FIG. 1) uses a clustering algorithm to group skills that have similar attributes or features (or are semantically similar). In some example embodiments, the skills can be clustered into small groups and those small groups can then be clustered into larger groups to form a hierarchy.

In some example embodiments, once skills have been clustered into groups and those groups arranged in a hierarchy, the social networking system can use that information to identify appropriate skills in a plurality of situations. For example, if a member requests a recommendation for a course to learn a first skill, the social networking system (e.g., the social networking system 120 in FIG. 1) will determine whether any courses in the list of courses teach the first skill.

In some example embodiments, the social networking system (e.g., the social networking system 120 in FIG. 1) determines that there are no courses that teach the first skill (or not enough to populate a recommendation screen). The social networking system (e.g., the social networking system 120 in FIG. 1) then uses the vector attribute score for the first skill and determines a distance from a plurality of other skills. In some example embodiments, the plurality of other skills are ranked based on their similarity to the first skill.

In some example embodiments, the social networking system (e.g., the social networking system 120 in FIG. 1) identifies courses that teach the highest ranked skill. In some example embodiments, the social networking system (e.g., the social networking system 120 in FIG. 1) can then transmit the courses to the client system for display.

FIG. 1 is a network diagram depicting a client-server system environment 100 that includes various functional components of a social networking system 120, in accordance with some example embodiments. The client-server system environment 100 includes one or more client systems 102 and the social networking system 120. One or more communication networks 110 interconnect these components. The communication networks 110 may be any of a variety of network types, including local area networks (LANs), wide area networks (WANs), wireless networks, wired networks, the Internet, personal area networks (PANS), or a combination of such networks.

In some example embodiments, the client system 102 is an electronic device, such as a personal computer (PC), a laptop, a smartphone, a tablet, a mobile phone, or any other electronic device capable of communication with the communication network 110. The client system 102 includes one or more client applications 104, which are executed by the client system 102. In some example embodiments, the client application(s) 104 include one or more applications from a set consisting of search applications, communication applications, productivity applications, game applications, word processing applications, or any other useful applications. The client application(s) 104 include a web browser. The client system 102 uses a web browser to send and receive requests to and from the social networking system 120 and to display information received from the social networking system 120.

In some example embodiments, the client system 102 includes an application specifically customized for communication with the social networking system 120 (e.g., a LinkedIn iPhone application). In some example embodiments, the social networking system 120 is a server system that is associated with one or more services.

In some example embodiments, the client system 102 sends a request to the social networking system 120 for a course recommendation based on a skill identified by a member. For example, a member of the social networking system 120 uses the client system 102 to log into the social networking system 120 and request recommendations for courses that teach a desired skill. In response, the client system 102 receives, from the social networking system 120, a list of course recommendations for courses that teach the skills, and displays that ranked list of skills in a user interface on the client system 102.

In sonic example embodiments, as shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various example embodiments have been omitted from FIG. 1. However, a skilled artisan will readily recognize that various additional functional modules and engines may be used with a social networking system 120, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although the social networking system 120 is depicted in FIG. 1 as having a three-tiered architecture, the various example embodiments are by no means limited to this architecture.

As shown in FIG. 1, the front end consists of a user interface module(s) (e.g., a web server) 122, which receives requests from various client systems 102 and communicates appropriate responses to the requesting client systems 102. For example, the user interface module(s) 122 may receive requests in the form of Hypertext Transfer Protocol (HTTP) requests, or other web-based, application programming interface (API) requests. The client system 102 may be executing conventional web browser applications or applications that have been developed for a specific platform to include any of a wide variety of mobile devices and operating systems.

As shown in FIG. 1, the data layer includes several databases, including databases for storing data for various members of the social networking system 120, including member profile data 130, skill data 132, course data 134, and social graph data 138, which is data stored in a particular type of database that uses graph structures with nodes, edges, and properties to represent and store data. Of course, in various alternative example embodiments, any number of other entities might be included in the social graph (e.g., companies, organizations, schools and universities, religious groups, non-profit organizations, governmental organizations, non-government organizations (NGOs), and any other group) and, as such, various other databases may be used to store data corresponding with other entities.

Consistent with some example embodiments, when a person initially registers to become a member of the social networking system 120, the person will be prompted to provide some personal information, such as his or her name, age (e.g., birth date), gender, contact information, home town, address, educational background (e.g., schools, majors, etc.), current job title, job description, industry, employment history, skills, professional organizations, memberships with other online service systems, and so on. This information is stored, for example, in the member profile data 130.

In some example embodiments, the member profile data 130 includes or is associated with member interaction data. In other example embodiments, the member interaction data is distinct from, but associated with, the member profile data 130. The member interaction data stores information detailing the various interactions each member has through the social networking system 120. In some example embodiments, interactions include posts, likes, messages, adding or removing social contacts, and adding or removing member content items (e.g., a message or like), while others are general interactions (e.g., posting a status update) and are not related to another particular member. Thus, if a given member interaction is directed towards or includes a specific member, that member is also included in the membership interaction record.

In some example embodiments, the member profile data 130 includes skill data 132. In other example embodiments, the skill data 132 is distinct from, but associated with, the member profile data 130. The skill data 132 stores skill data for each member of the social networking system 120. Skill data 132 may include both explicit skills and implicit skills.

In some example embodiments, explicit skills are skills that the member is determined to have based on skill information directly received from the member. For example, a member reports that they have skills in using the C++, Java, CSS, and Python programming languages. Because the member directly reported these skills, they are considered explicit skills. In some example embodiments, explicit skills are listed on a member's public profile.

In some example embodiments, one or more skills are determined based on an analysis of the non-skill data stored in a member profile. Skills determined in this way are considered implicit skills. Implicit skills are determined or inferred by analyzing data stored in a member profile, including but not limited to education, job history, hobbies, friends, skill ratings, interests, projects a member has worked on, activity on the social networking system 120, and member submitted comments. In some example embodiments, implicit skills may also be called inferred skills or skills a member may have. For example, member A lists an undergraduate degree in architecture and has a past job history that includes Project Architect for at least three different projects. Using a table that indicates likely skills for members who have had certain titles, jobs, educational experience, and so on, the social networking system 120 determines that member A has a skill in AutoCAD even though the member has not directly reported having that skill. In some example embodiments, implicit skills are not listed on a member's public profile.

In some example embodiments, the course data 134 includes educational material access history data. In some example embodiments, educational material access history data includes one or more material access records, each of which details a particular instance of the member accessing a particular piece of educational material. In some example embodiments, each material access record details the member who accessed the educational materials, the time of the access, the course associated with the educational materials, and how much of the educational materials was read, watched, listened to, or completed.

In some example embodiments, the course data 134 also includes educational materials. Each piece of educational material is a media content item. Media content items include text items, video content items, audio content items, interactive content items (e.g., quizzes and so on), and any other materials that can be used in an educational course. In some example embodiments, each piece of educational material is associated with a specific educational course. In some example embodiments, the course data 134 also includes metadata about each course, such as the content covered by a course, its subject area, the skills that the course covers, and so on,

Once registered, a member may invite other members, or be invited by other members, to connect via the social networking system 120. A “connection” may include a bilateral agreement by the members, such that both members acknowledge the establishment of the connection. Similarly, in some example embodiments, a member may elect to “follow” another member. In contrast to establishing a “connection,” the concept of “following” another member typically is a unilateral operation and, at least in some example embodiments, does not include acknowledgement or approval by the member that is being followed. When one member follows another, the member who is following may receive automatic notifications about various interactions undertaken by the member being followed. In addition to following another member, a member may elect to follow a company, a topic, a conversation, or some other entity, which may or may not be included in the social graph. Various other types of relationships may exist between different entities, and are represented in the social graph data 138.

The social networking system 120 may provide a broad range of other applications and services that allow members the opportunity to share and receive information, often customized to the interests of the member. In some example embodiments, the social networking system 120 may include a photo sharing application that allows members to upload and share photos with other members. As such, at least in some example embodiments, a photograph may be a property or entity included within a social graph. In some example embodiments, members of the social networking system 120 may be able to self-organize into groups, or interest groups, around a subject matter or topic of interest. In some example embodiments, the data for a group may be stored in a database. When a member joins a group, his or her membership in the group will be reflected in the member profile data 130 and the social graph data 138.

In some example embodiments, the application logic layer includes various application server modules, which, in conjunction with the interface module(s) 122, receive member recommendation requests from a large variety of client systems 102 and return recommendations to those client systems 102.

In some example embodiments, a vector generation module 124 and a vector comparison module 126 can also be included in the application logic layer. Of course, other applications or services that utilize the vector generation module 124 and the vector comparison module 126 may be separately implemented in their own application server modules.

As illustrated in FIG. 1, with some example embodiments, the vector generation module 124 and the vector comparison module 126 are implemented as services that operate in conjunction with various application server modules. For instance, any number of individual application server modules can invoke the functionality of the vector generation module 124 and the vector comparison module 126. However, with various alternative example embodiments, the vector generation module 124 and the vector comparison module 126 may be implemented as their own application server modules such that they operate as stand-alone applications.

Generally, the vector generation module 124 receives a recommendation request that includes at least one skill of interest. In some example embodiments, the vector generation module 124 converts the skill of interest into a skill attribute vector. In some example embodiments, the skill attribute vector is generated based on a model that was trained using historical skill and course data to determine common attributes of skills and courses. In some example embodiments, as new skills and additional data about member preferences are added, the vector generation module 124 updates the model to incorporate the new data. In some example embodiments, the model is able to convert skill names and descriptions into a common skill attribute vector, such that they can be compared mathematically without direct control by a member or administrator.

The vector comparison module 126 uses a skill attribute vector created by the vector generation module 124 for a particular skill to compare to a plurality of other skill attribute vectors to determine the most similar skills. In some example embodiments, the vector comparison module 126 compares the skill attribute vector of the search query to each skill attribute vector stored in the skill data 132 and generates a match score for each.

In some example embodiments, the vector comparison module 126 generates a distance score between the two skill attribute vectors (wherein a distance score represents the similarity between the two skill attribute vectors). The vector comparison module 126 then ranks each skill attribute vector based on the associated score.

In some example embodiments, the vector comparison module 126 determines that a particular number of course recommendations are desired (e.g., based on the number of recommendations that are designed to fit in a particular web page) and selects skills that have enough associated courses to fill the number of course recommendations based on rank. For each selected skill attribute vector, the vector comparison module 126 receives the associated skill record and identifies one or more courses associated with each skill.

In some example embodiments, the selected courses are then transmitted to the client system 102 for display.

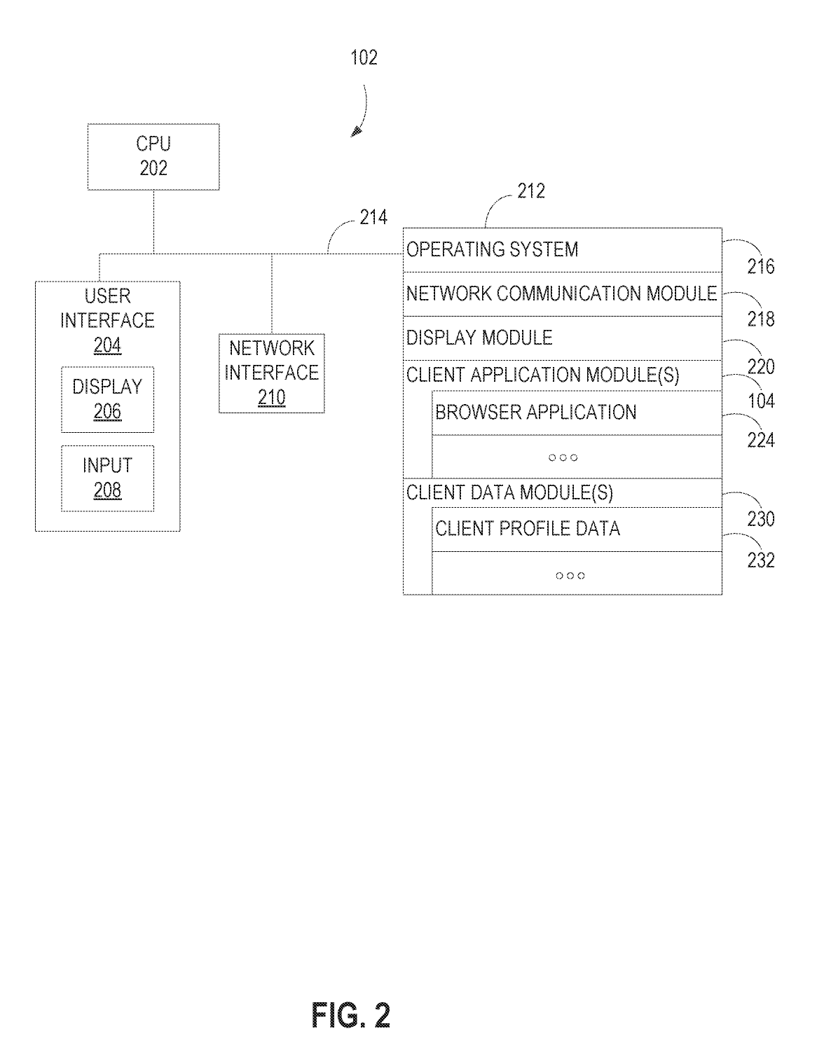

FIG. 2 is a block diagram further illustrating the client system 102, in accordance with some example embodiments. The client system 102 typically includes one or more central processing units (CPUs) 202, one or more network interfaces 210, memory 212, and one or more communication buses 214 for interconnecting these components. The client system 102 includes a user interface 204. The user interface 204 includes a display device 206 and optionally includes an input means 208 such as a keyboard, a mouse, a touch sensitive display, or other input buttons. Furthermore, some client systems 102 use a microphone and voice recognition to supplement or replace the keyboard.

The memory 212 includes high-speed random-access memory, such as dynamic random-access memory (DRAM), static random-access memory (SRAM), double data rate random-access memory (DDR RAM), or other random-access solid state memory devices; and may include non-volatile memory, such as one or more magnetic disk storage devices, optical disk storage devices, flash memory devices, or other non-volatile solid state storage devices. The memory 212 may optionally include one or more storage devices remotely located from the CPU(s) 202. The memory 212, or alternatively, the non-volatile memory device(s) within the memory 212, comprise(s) a non-transitory computer-readable storage medium.

In some example embodiments, the memory 212, or the computer-readable storage medium of the memory 212, stores the following programs, modules, and data structures, or a subset thereof:
an operating system 216 that includes procedures for handling various basic system services and for performing hardware-dependent tasks;
a network communication module 218 that is used for connecting the client system 102 to other computers via the one or more network interfaces 210 (wired or wireless) and one or more communication networks 110, such as the Internet, other WANs, LANs, metropolitan area networks (MANs), etc.;
a display module 220 for enabling the information generated by the operating system 216 and client application(s) 104 to be presented visually on the display device 206;
one or more client application(s) 104 for handling various aspects of interacting with the social networking system (e.g., system 120 in FIG. 1), including but not limited to:
   a browser application 224 for requesting information from the social networking system 120 (e.g., skills gap rankings) and receiving responses from the social networking system 120; and
client data module(s) 230 for storing data relevant to clients, including but not limited to:
   client profile data 232 for storing profile data related to a member of the social networking system 120 associated with the client system 102.

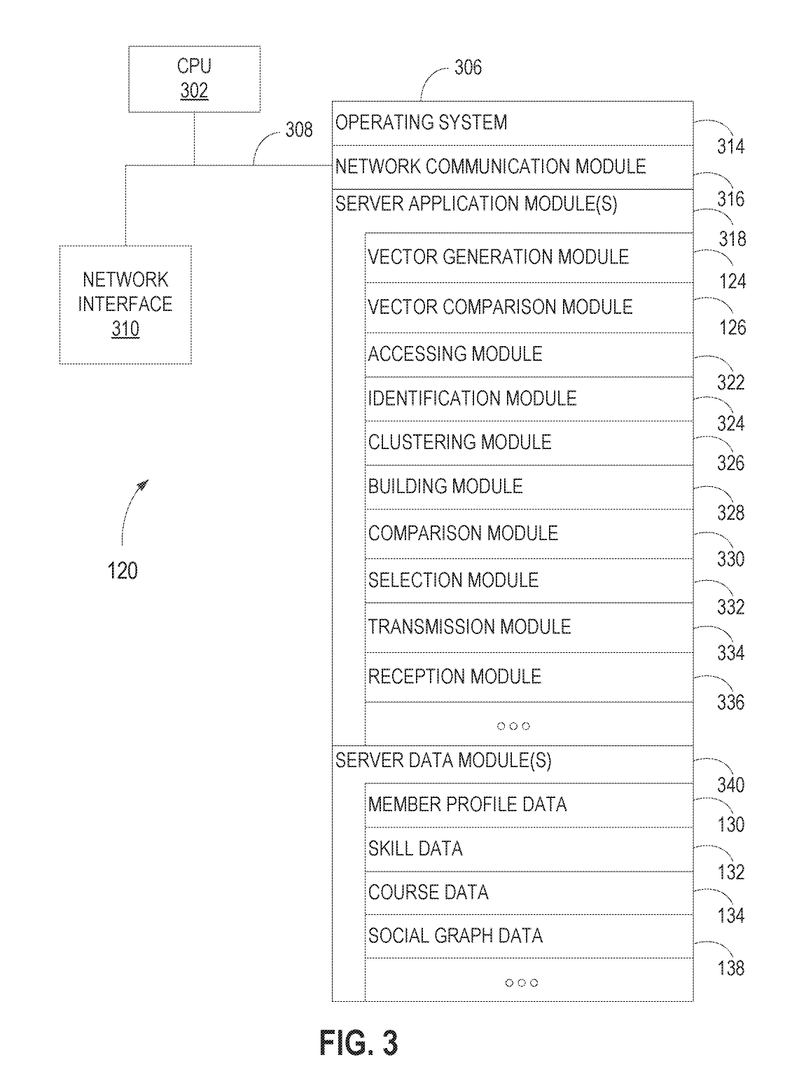

FIG. 3 is a block diagram further illustrating the social networking system 120, in accordance with some example embodiments. Thus, FIG. 3 is an example embodiment of the social networking system 120 in FIG. 1. The social networking system 120 typically includes one or more CPUs 302, one or more network interfaces 310, memory 306, and one or more communication buses 308 for interconnecting these components. The memory 306 includes high-speed random-access memory, such as DRAM, SRAM, DDR RAM, or other random-access solid state memory devices; and may include non-volatile memory, such as one or more magnetic disk storage devices, optical disk storage devices, flash memory devices, or other non-volatile solid state storage devices. The memory 306 may optionally include one or more storage devices remotely located from the CPU(s) 302.

The memory 306, or alternatively the non-volatile memory device(s) within the memory 306, comprises a non-transitory computer-readable storage medium. In some example embodiments, the memory 306, or the computer-readable storage medium of the memory 306, stores the following programs, modules, and data structures, or a subset thereof:
an operating system 314 that includes procedures for handling various basic system services and for performing hardware-dependent tasks;
a network communication module 316 that is used for connecting the social networking system 120 to other computers via the one or more network interfaces 310 (wired or wireless) and one or more communication networks 110, such as the Internet, other WANs, LANs, MANs, and so on;
one or more server application modules 318 for performing the services offered by the social networking system 120, including but not limited to:
   a vector generation module 124 for generating a skill attribute vector for a particular skill based on the skill name and/or a description of the skill;
   a vector comparison module 126 for comparing a skill attribute vector for a first skill with the skill attribute vectors for one or more other skills to generate a similarity score between two skills;
   an accessing module 322 for accessing skill data 132;
   an identification module 324 for identifying one or more courses associated with a particular skill based on information about the content covered or taught by the course;
   a clustering module 326 for clustering skills based on the position of their associated skill attribute vector in a multi-dimensional vector space;
   a building module 328 for creating hierarchies out of the grouped skills by grouping small groups into larger groups;
   a comparison module 330 for comparing the skill attribute vector for a first skill with a skill attribute vector of a second skill;
   a selection module 332 for selecting one or more skills based on the comparison with the first skill;
   a transmission module 334 for transmitting one or more selected course recommendations to a client system (e.g., the client system 102 in FIG. 1) for display; and
   a reception module 336 for receiving a recommendation request from a member; and
server data module(s) 340, holding data related to the social networking system 120, including but not limited to:
   member profile data 130, including both data provided by the member, who will be prompted to provide some personal information, such as his or her name, age (e.g., birth date), gender, interests, contact information, home town, address, educational background (e.g., schools, majors, etc.), current job title, job description, industry, employment history, skills, professional organizations, memberships to other social networks, customers, past business relationships, and seller preferences; and inferred member information based on the member's activity, social graph data 138, overall trend data for the social networking system 120, and so on;
   skill data 132 including data representing a member's stated or inferred skills;
   course data 134 including data describing one or more courses, data about past course access by members, and educational material data; and.
   social graph data 138 including data that represents members of the social networking system 120 and the social connections between them.

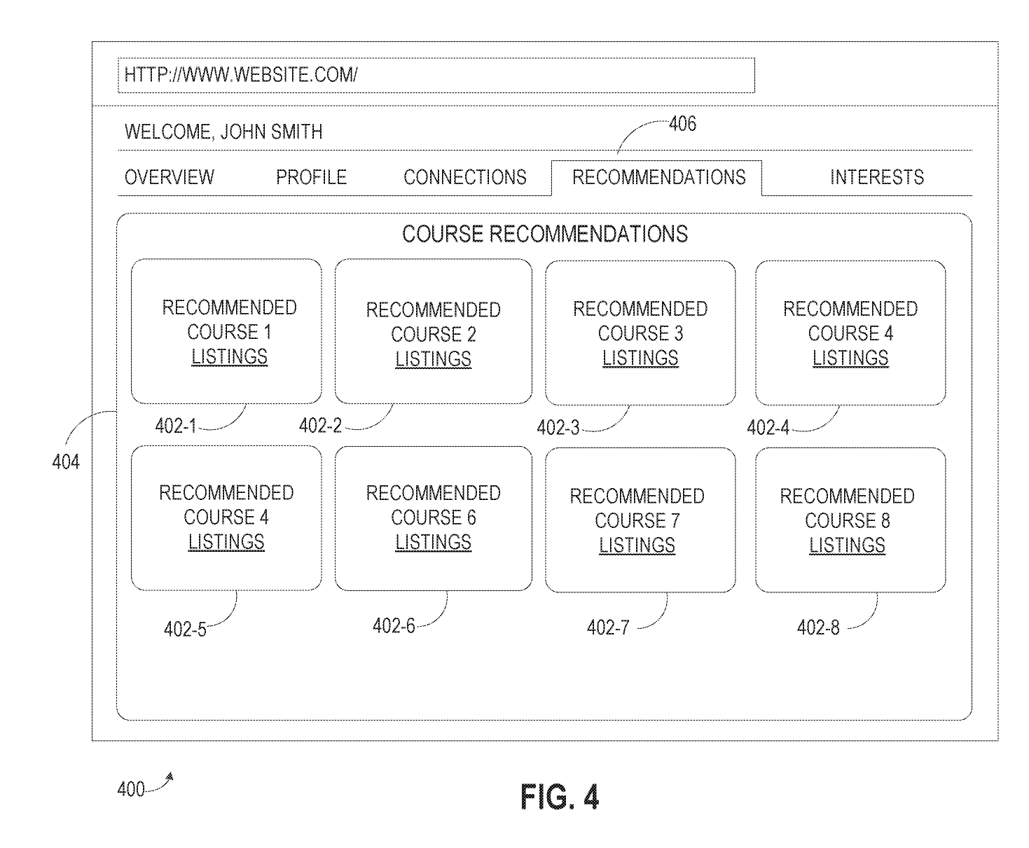

FIG. 4 is a user interface diagram illustrating an example of a user interface 400 or web page that incorporates a list of course recommendations to a member of a social networking system (e.g., the social networking system 120 in FIG. 1). In the example user interface 400 of FIG. 4, the displayed user interface 400 represents a web page for a member of the social networking system (e.g., the social networking system 1.20 in FIG. 1) with the name John Smith.

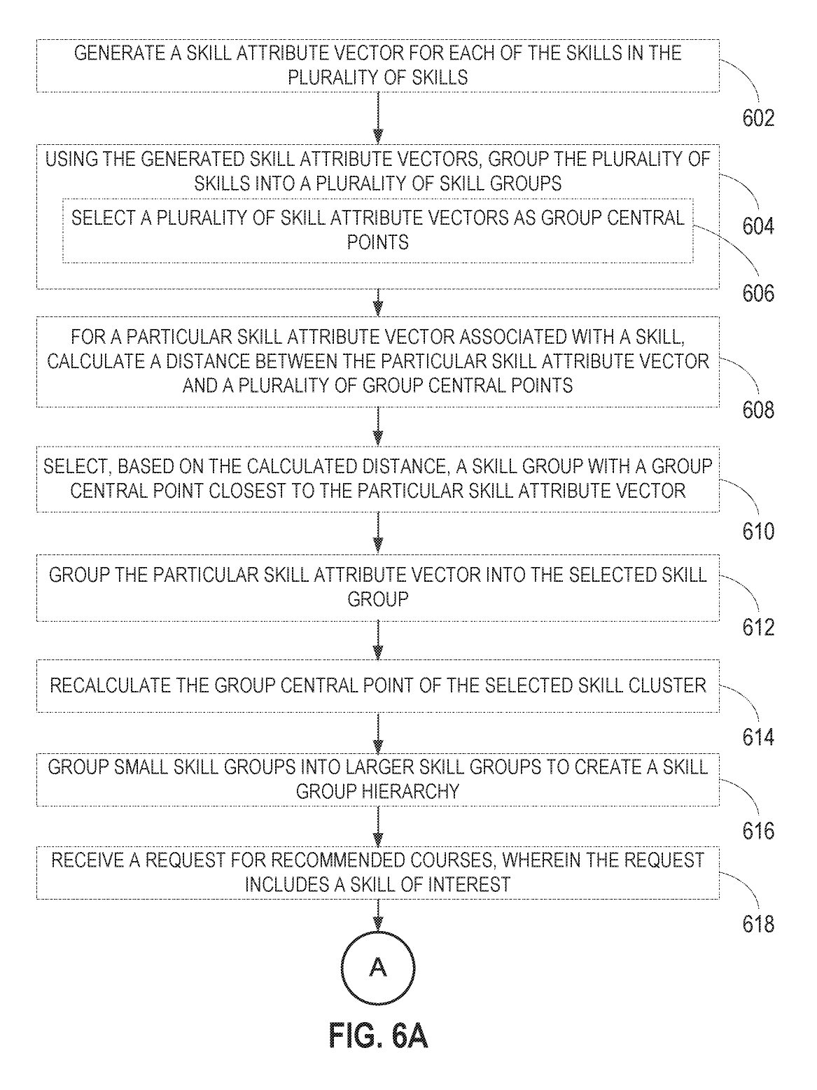

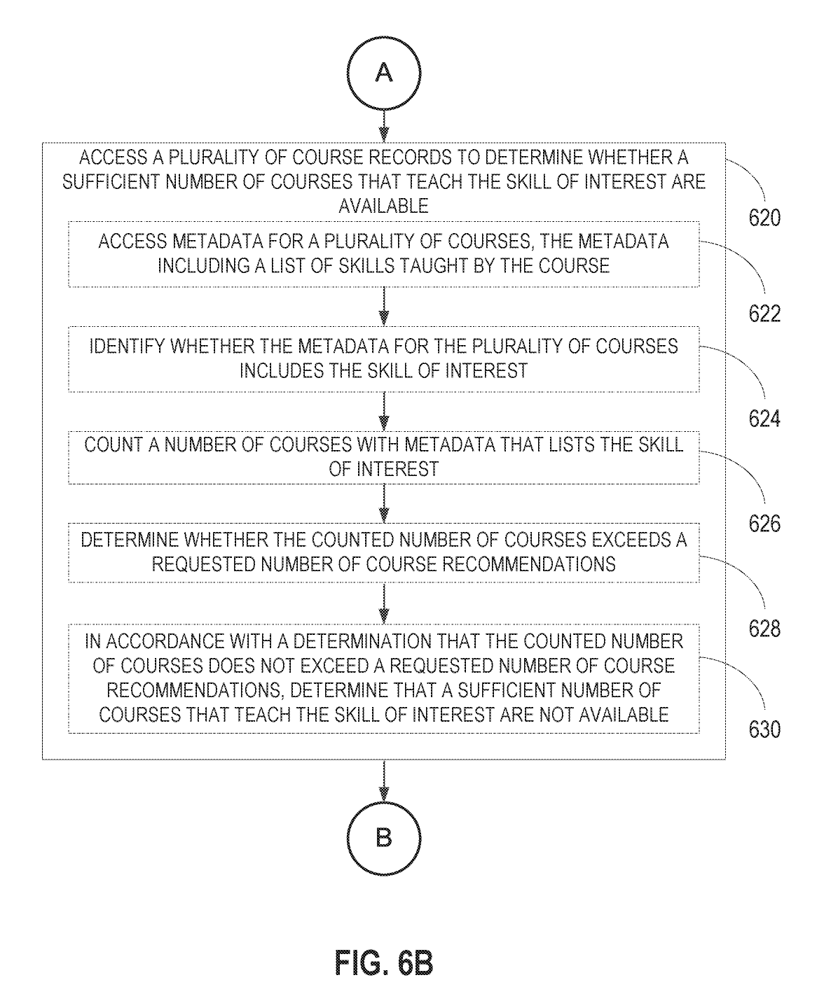

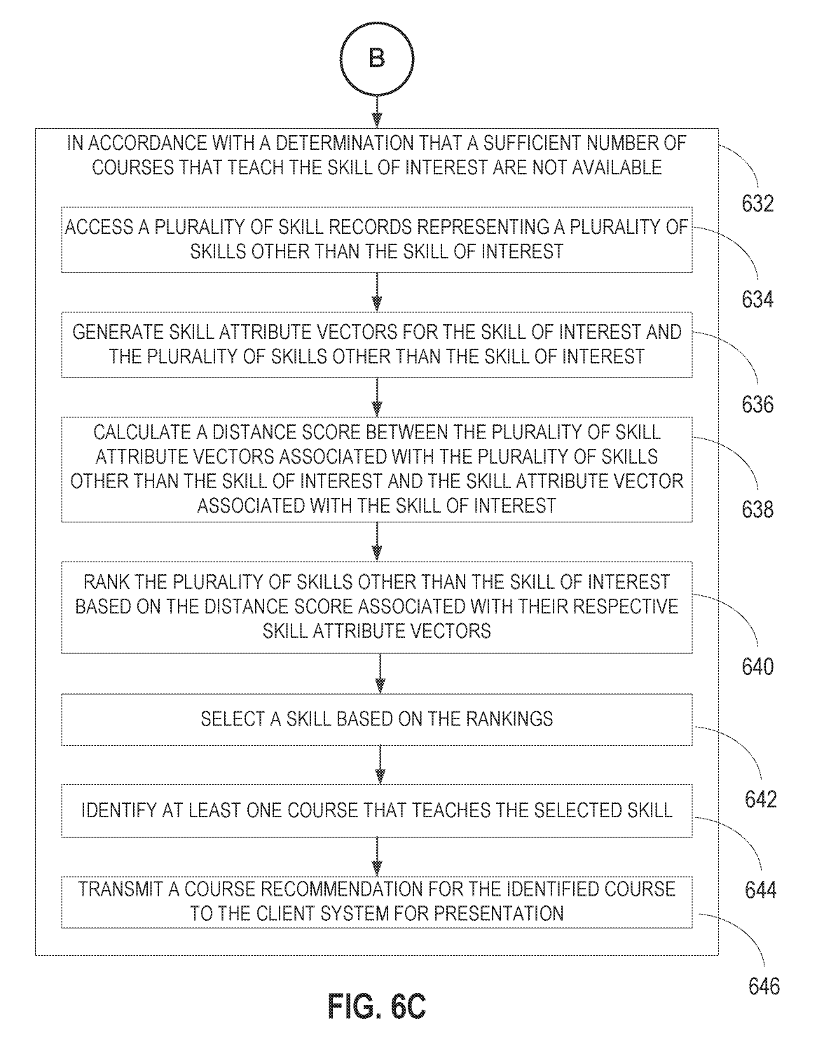

As can be seen, a recommendations tab 406 has been selected and a page 404 of relevant course recommendations 402 is displayed. The course recommendations 402 are determined based on the skills possessed by the requesting member and members similar to the requesting member. Specifically, courses that teach skills that the requesting member does not have but that are possessed by members who are or were similar to the requesting member (determined as shown below in FIGS. 6A-6C) are more likely to be recommended. Each course recommendation 402-1 to 402-8 displays a link to listings 402-1 to 402-8 that contain additional information about the course, including information about the course contents, the course prerequisites, and how to access the course or enroll in the course.

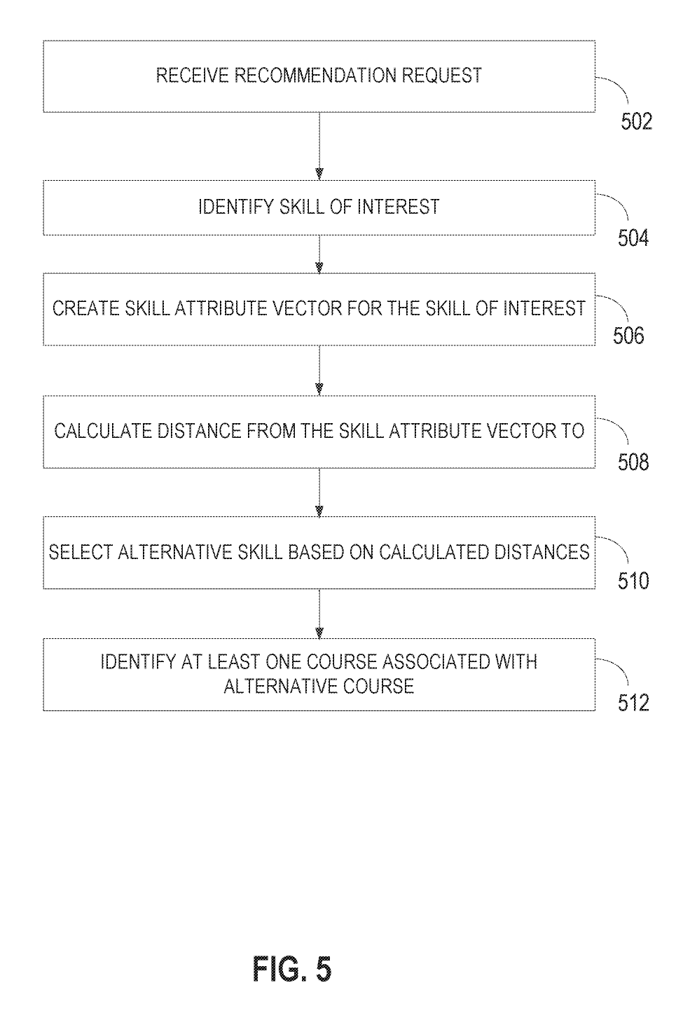

FIG. 5 is a flow diagram illustrating a method, in accordance with some example embodiments, for using attribute vectors for categorizing skills and using those categorizations to recommend courses to members of a social networking system (e.g., the social networking system 120 in FIG. 1). Each of the operations shown in FIG. 5 may correspond to instructions stored in a computer memory or computer-readable storage medium. In some embodiments, the method described in FIG. 5 is performed by the social networking system (e.g., the social networking system 120 in FIG. 1). However, the method described can also be performed by any other suitable configuration of electronic hardware.

In some embodiments the method is performed by a social networking system (e.g., the social networking system 120 in FIG. 1) including one or more processors and memory storing one or more programs for execution by the one or more processors.

In some example embodiments, the social networking system (e.g., the social networking system 120 in FIG. 1) receives (502) a recommendation request. In some example embodiments, the recommendation request is generated by a member specially requesting course recommendations (e.g., the member selects a “request recommendation” button or link). In other example embodiments, the recommendation request is generated by the social networking system (e.g., the social networking system 120 in FIG. 1) to populate a recommendation page without a specific request from the member.

In some example embodiments, the social networking system (e.g., the social networking system 120 in FIG. 1) identifies (504) at least one skill of interest to the member. In some example embodiments, the member designates a particular skill (or list of skills) as being of interest to the member. In other example embodiments, the social networking system (e.g., the social networking system 120 in FIG. 1) infers a skill of interest based on the skills the member already possesses, the member's industry and job history, and the skills other members possess.

In some example embodiments, the social networking system (e.g., the social networking system 120 in FIG. 1) creates a skill attribute vector (506) for the skill of interest.

In some example embodiments, the social networking system (e.g., the social networking system 120 in FIG. 1) creates a model that maps skills and their descriptions to skill attribute vectors. In some example embodiments, the model is trained using existing skill data 132 (e.g., information about which skills each member has and the order and timing with which they were acquired). In some example embodiments, the model itself is constructed using computer learning techniques such as decision tree learning, artificial neural networks and deep learning techniques, support vector machines, Bayesian networks, and so on.

For example, the social networking system (e.g., the social networking system 120 in FIG. 1) identifies existing skill groupings and/or hierarchies and skill groupings based on member skills sets (e.g., skills that are often found together may have similarities). Using this existing skill data, the social networking system (e.g., the social networking system 120 in FIG. 1) can evaluate the model and determine whether the skill attribute vectors are appropriate.

In some example embodiments, the social networking system (e.g., the social networking system 120 in FIG. 1) creates a skill attribute vector associated with a skill using the model. For example, the social networking system (e.g., the social networking system 120 in FIG. 1) has created a model that uses the name and the description of a skill to generate a skill attribute vector. The skill attribute vector is a series of numbers that represent the location (e.g., where location is based on the attributes of the skill) of the skill in a multi-dimensional vector space.

In a very simplified example, for a two-dimensional space, with (x,y) values that range from 0 to 1, a model is trained to represent different areas in the two-dimensional space with different skill attributes. Each skill is then mapped to a specific (x,y) pair by the model. The social networking system (e.g., the social networking system 120 in FIG. 1) then determines the similarity between two skills by calculating the distance between the two points in (x,y) space.

In general, the skill attribute vector will be mapped into a vector with hundreds of dimensions, such that very complicated skill attributes can be represented by the model.

Thus the vector (v) can be represented as:

V=[w₁, w₂, w₃, . . . wₙ]

where the attribute feature vector (V) includes n different weights (w). In some example embodiments, each weight can be used to generate a weight for a given attribute (a) in a particular skill(s).

$${w}_{a , p} = a {f}_{a , p} \cdot log \frac{\vert S \vert}{\vert \{ {s}^{1} ∈ S \vert a ∈ {s}^{1} \} \vert}$$

where the weight for a given attribute in a particular profile (w_{a,p}) is calculated by determining a frequency for a given attribute in a particular skill description (af_{a,s}). |S| is the total number of skills in the whole corpus and s¹ is the current skill and description.

In some example embodiments, the social networking system (e.g., the social networking system 125 in FIG. 1) then calculates (508) a distance between the generated skill attribute vector for a skill of interest and the skill attribute vectors for a plurality of other skills.

In some example embodiments, the similarity between two skill attribute vectors (e.g., A and B) is calculated using a cosine similarity formula such as:

$$similarity ( A , B ) = \frac{{\sum }_{i = 1}^{n} {A}_{i} {B}_{i}}{√ {\sum }_{i = 1}^{n} {A}_{i}^{2} √ {\sum }_{i = 1}^{n} {B}_{i}^{2}}$$

In this example, the cosine similarity will result in a score that ranges from −1 (exactly opposite) (exactly the same) with 0 representing no correlation.

In some example embodiments, the social networking system (e.g., the social networking system 120 in FIG. 1) ranks the list of potential matching skills based on their calculated similarity score to the skill of interest. In some example embodiments, the social networking system (e.g., the social networking system 120 in FIG. 1) selects (510) an alternative skill based on the rankings.

In some example embodiments, the social networking system (e.g., the social networking system 120 in FIG. 1) then identifies (512) at least one course associated with the alternative skill. In some example embodiments, the social networking system (e.g., the social networking system 120 in FIG. 1) can then transmit the identified course to the client system (e.g., the client system 102 in FIG. 1) for recommendation.

FIG. 6A is a flow diagram illustrating a method, in accordance with some example embodiments, for clustering skills using deep learning techniques at a social networking system (e.g., the social networking system 120 in FIG. 1). Each of the operations shown in FIG. 6A may correspond to instructions stored in a computer memory or computer-readable storage medium. Optional operations are indicated by dashed lines (e.g., boxes with dashed-line borders). In some embodiments, the method described in FIG. 6A is performed by the social networking system (e.g., the social networking system 120 in FIG. 1) However, the method described can also be performed by any other suitable configuration of electronic hardware.

In some embodiments the method is performed by a social networking system (e.g., the social networking system 120 in FIG. 1) including one or more processors and memory storing one or more programs for execution by the one or more processors.

In some example embodiments, the social networking system (e.g., the social networking system 120 in FIG. 1) stores a plurality of skill records, each skill record including information about a particular skill including the name of the skill and a description of the skill.

For a plurality of skills stored in a database at the social networking system (e.g., the social networking system 120 in FIG. 1), the social networking system (e.g., the social networking system 120 in FIG. 1) generates (602) a skill attribute vector for each of the skills in the plurality of skills. As noted above, a skill attribute vector is generated by using information about the skill as input to a vector generation module. An example of such a model is the word2vec model that uses shallow, two-layer neural networks to reconstruct the context of words or groups of words.

In some example embodiments, using the generated skill attribute vectors, the social networking system (e.g., the social networking system 120 in FIG. 1) groups (604) the plurality of skills into a plurality of skill groups. Grouping can be accomplished by the social networking system (e.g., the social networking system 120 in FIG. 1) selecting (606) a plurality of skill attribute vectors as group central points. In some example embodiments, the social networking system (e.g., the social networking system 120 in FIG. 1) uses a technique such as Forgy Partitioning or Random Partitioning. Forgy partition randomly chooses n skills from the data set and uses these as initial central points. Random partitioning initially randomly assigns a group to each skill, then proceeds with a series of update steps to improve the grouping.

Once the initial central points have been determined, the skills can then be grouped (e.g., clustered.) Clustering can be accomplished with a wide variety of clustering algorithms. To do this, the social networking system (e.g., the social networking system 120 in FIG. 1) calculates (608) a distance between the particular skill attribute vector and a plurality of group central points. One method for calculating these distances is a k-means clustering algorithm. To use k-means clustering for skills, each skill is assigned to a cluster whose central point is the closest using an equation such as:

Sᵢ^{(t)}={xₚ:∥sₚ−mᵢ^{(t)}∥²≤∥xₚ−mⱼ^{(t)}∥²∀j, 1≤j≤k}

where each skill (x) is assigned to one cluster S at time t, based on which center point (m with coordinates i, j) is closest to the position of the skill in the vector space,

In some example embodiments, the social networking system (e.g., the social networking system 120 in FIG. 1) selects (610), based on the calculated distance, a skill group with a group central point closest to the particular skill attribute vector. In some example embodiments, the social networking system (e.g., the social networking system 120 in FIG. 1) then groups (612) the particular skill attribute vector into the selected skill group or cluster.

Once skills have been assigned to clusters, the social networking system (e.g., the social networking system 120 in FIG. 1) recalculates (614) the group central point of the selected skill cluster with a formula such as:

$${m}_{i}^{t + 1} = \frac{1}{{S}_{i}^{( t )}} {\sum }_{{x}_{j} ∈ {S}_{i}^{( t )}} {x}_{j}$$

Once new central points are determined, the skills are clustered again. Once the skills stop shifting between clusters with each update, the clusters are determined to have settled.

In some example embodiments, the social networking system (e.g., the social networking system 120 in FIG. 1) groups (616) small skill groups into larger skill groups to create a skill group hierarchy. For example, skill groups can themselves be grouped using the same techniques that are used for grouping skills into clusters.

In some example embodiments, the social networking system (e.g., the social networking system 120 in FIG. 1) receives (618) a request for recommended courses, wherein the request includes a skill of interest. As noted above, the request is generated by a specific action of a member (e.g., clicking on a request recommendation button). In other example embodiments, the request is generated within the social networking system (e.g., the social networking system 120 in FIG. 1) to add recommendations to a member profile without any particular action from the member.

FIG. 6B is a flow diagram illustrating a method, in accordance with some example embodiments, for clustering skills using deep learning techniques at a social networking system (e.g., the social networking system 120 in FIG. 1). Each of the operations shown in FIG. 6B may correspond to instructions stored in a computer memory or computer-readable storage medium. Optional operations are indicated by dashed lines (e.g., boxes with dashed-line borders). In some embodiments, the method described in FIG. 6B is performed by the social networking system (e.g., the social networking system 120 in FIG. 1). However, the method described can also be performed by any other suitable configuration of electronic hardware. FIG. 6B continues the flow illustrated in FIG. 6A.

In some embodiments the method is performed by a social networking system (e.g., the social networking system 120 in FIG. 1) including one or more processors and memory storing one or more programs for execution by the one or more processors.

In sonic. example embodiments, the social networking system (e.g., the social networking system 120 in FIG. 1) accesses (620) a plurality of course records to determine whether a sufficient number of courses that teach the skill of interest are available. To do so, the social networking system (e.g., the social networking system 120 in FIG. 1) accesses (622) metadata for a plurality of courses, the metadata including a list of skills taught by the course.

In some example embodiments, the social networking system (e.g., the social networking system 120 in FIG. 1) identifies (624) whether the metadata for the plurality of courses includes the skill of interest.

In some example embodiments, the social networking system (e.g., the social networking system 120 in FIG. 1) counts (626) a number of courses with metadata that list the skill of interest. In some example embodiments, the social networking system (e.g., the social networking system 120 in FIG. 1) determines (626) whether the counted number of courses exceeds a requested number of course recommendations. In some example embodiments, the requested number of course recommendations is based on a user interface page for displaying recommendations. Thus the social networking system (e.g., the social networking system 120 in FIG. 1) determines that a sufficient number of course recommendations is at least the number needed to file a page in the recommendation user interface.

In accordance with a determination that the counted number of courses does not exceed a requested number of course recommendations, the social networking system (e.g., the social networking system 120 in FIG. 1) determines (630) that a sufficient number of courses that teach the skill of interest are not available.

FIG. 6C is a flow diagram illustrating a method, in accordance with some example embodiments, for clustering skills using deep learning techniques at a social networking system (e.g., the social networking system 120 in FIG. 1). Each of the operations shown in FIG. 6C may correspond to instructions stored in a computer memory or computer-readable storage medium. Optional operations are indicated by dashed lines (e.g., boxes with dashed-line borders). In some embodiments, the method described in FIG. 6C is performed by the social networking system (e.g., the social networking system 120 in FIG. 1). However, the method described can also be performed by any other suitable configuration of electronic hardware. FIG. 6C continues the flow illustrated in FIGS. 6A and 6B.

In some embodiments the method is performed by a social networking system (e.g., the social networking system 120 in FIG. 1) including one or more processors and memory storing one or more programs for execution by the one or more processors.

In accordance with a determination (632) that a sufficient number of courses that teach the skill of interest are not available, the social networking system (e.g., the social networking system 120 in FIG. 1) accesses (634) a plurality of skill records representing a plurality of skills other than the skill of interest. In some example embodiments, the plurality of skills other than the skill of interest are identified based on existing skill classification methods (e,g., skills are sorted into skill areas). In other example embodiments, the skills are selected based on the group to which they belong (e.g., if the skills had been previously clustered) and the position of each group in a skill hierarchy of skills.

In some example embodiments, the social networking system (e.g., the social networking system 120 in FIG. 1) generates (636) skill attribute vectors for the skill of interest and the plurality of skills other than the skill of interest. As noted above, the skill attribute vectors are generated by a model or algorithm (e.g., word2Vec) and are represented by a series of values that map to a position in multi-dimensional space.

In some example embodiments, the social networking system (e.g., the social networking system 120 in FIG. 1) calculates (638) a distance score between the plurality of skill attribute vectors associated with the plurality of skills other than the skill of interest and the skill attribute vector associated with the skill of interest. As noted above, calculating a distance between two skill attribute vectors can be accomplished by calculating a cosine similarity.

In some example embodiments, the social networking system (e.g., the social networking system 120 in FIG. 1) ranks (640) the plurality of skills other than the skill of interest based on the distance score associated with their respective skill attribute vectors. In some example embodiments, the social networking system (e.g., the social networking system 120 in FIG. 1) selects (642) a skill based on the rankings. For example, the social networking system (e.g., the social networking system 120 in FIG. 1) selects the highest ranked skill.

In some example embodiments, the social networking system. (e.g., the social networking system 120 in FIG. 1) identifies (644) at least one course that teaches the selected skill and transmits (646) a course recommendation for the identified course to the client system 102 for presentation.

### Software Architecture

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

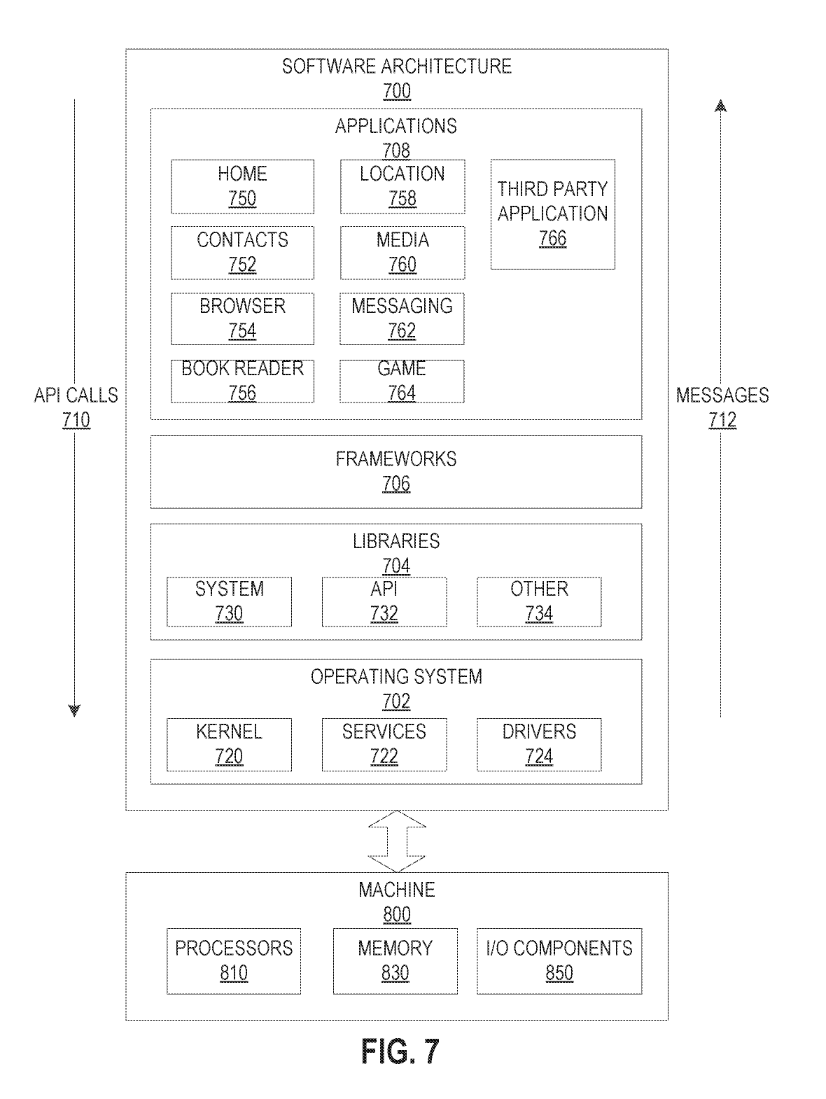

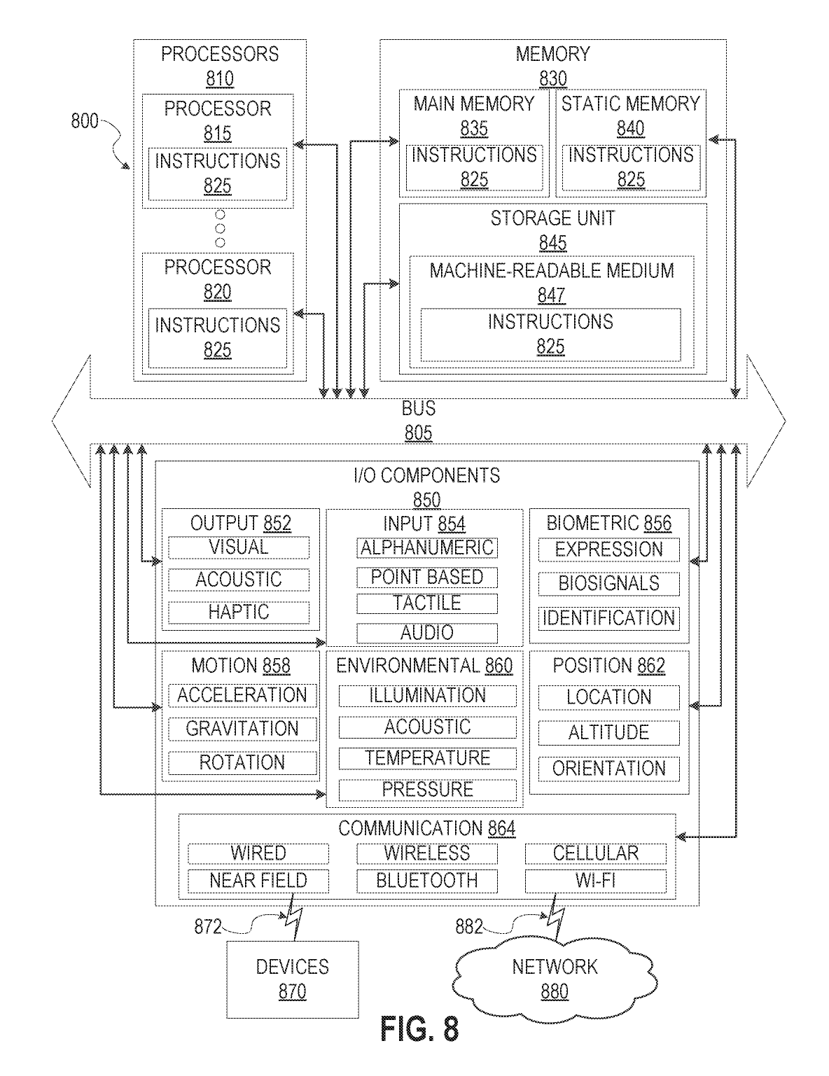

FIG. 7 is a block diagram illustrating an architecture of software 700, which may be installed on any one or more of the devices of FIG. 1. FIG. 7 is merely a non-limiting example of an architecture of software 700 and it will be appreciated that many other architectures may be implemented to facilitate the functionality described herein. The software 700 may be executing on hardware such as a machine 800 of FIG. 8 that includes processors 810, memory 830, and I/O components 850. In the example architecture of FIG. 7, the software 700 may be conceptualized as a stack of layers where each layer may provide particular functionality. For example, the software 700 may include layers such as an operating system 702, libraries 704, frameworks 706, and applications 708. Operationally, the applications 708 may invoke API calls 710 through the software stack and receive messages 712 in response to the API calls 710.

The operating system 702 may manage hardware resources and provide common services. The operating system 702 may include, for example, a kernel 720, services 722, and drivers 724. The kernel 720 may act as an abstraction layer between the hardware and the other software layers. For example, the kernel 720 may be responsible for memory management, processor management (e.g., scheduling), component management, networking, security settings, and so on. The services 722 may provide other common services for the other software layers. The drivers 724 may be responsible for controlling and/or interfacing with the underlying hardware. For instance, the drivers 724 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 704 may provide a low-level common infrastructure that may be utilized by the applications 708. The libraries 704 may include system libraries 730 (e.g., C standard library) that may provide functions such as memory allocation functions, string manipulation functions, mathematic functions, and the like. In addition, the libraries 704 may include API libraries 732 such as media libraries (e.g., libraries to support presentation and manipulation of various media formats such as MPEG4, H.264, MP3, AAC, AMR, JPG, PN graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 704 may also include a wide variety of other libraries 734 to provide many other APIs to the applications 708.

The frameworks 706 may provide a high-level common infrastructure that may be utilized by the applications 708. For example, the frameworks 706 may provide various graphical user interface (GUI) functions, high-level resource management, high-level location services, and so forth. The frameworks 706 may provide a broad spectrum of other APIs that may be utilized by the applications 708, some of which may be specific to a particular operating system 702 or platform.

The applications 708 include a home application 750, a contacts application 752, a browser application 754, a book reader application 756, a location application 758, a media application 760, a messaging application 762, a game application 764, and a broad assortment of other applications, such as a third-party application 766. In a specific example, the third-party application 766 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 766 may invoke the API calls 710 provided by the mobile operating system, such as the operating system 702, to facilitate functionality described herein.

### Example Machine Architecture and Machine-Readable Medium

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 825 (e.g., software 700, a program, an application, an applets, an app, or other executable code) for causing the machine 800 to perform any one or more of the methodologies discussed herein may be executed. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but be not limited to, a server computer, a client computer, a PC, a tablet computer, a laptop computer, a netbook, a set-top box (STB), a personal digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 825, sequentially or otherwise, that specify actions to be taken by the machine 800. Further, while only a single machine 800 is illustrated, the term “machine” shall also be taken to include a collection of machines 800 that individually or jointly execute the instructions 825 to perform any one or more of the methodologies discussed herein.

The machine 800 may include processors 810, memory 830, and I/O components 850, which may be configured to communicate with each other via a bus 805. In an example embodiment, the processors 810 (e.g., a CPU, a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, a processor 815 and a processor 820, which may execute the instructions 825. The term “processor” is intended to include multi-core processors 810 that may comprise two or more independent processors 815, 820 (also referred to as “cores”) that may execute the instructions 825 contemporaneously. Although FIG. 8 shows multiple processors 810, the machine 800 may include a single processor 810 with a single core, a single processor 810 with multiple cores (e.g., a multi-core processor), multiple processors 810 with a single core, multiple processors 810 with multiple cores, or any combination thereof.

The memory 830 may include a main memory 835, a static memory 840, and a storage unit 845 accessible to the processors 810 via the bus 805. The storage unit 845 may include a machine-readable medium 847 on which are stored the instructions 825 embodying any one or more of the methodologies or functions described herein. The instructions 825 may also reside, completely or at least partially, within the main memory 835, within the static memory 840, within at least one of the processors 810 (e.g., within the processor's cache memory), or any suitable combination thereof, during execution thereof by the machine 800. Accordingly, the main memory 835, the static memory 840, and the processors 810 may be considered machine-readable media 847.

As used herein, the term “memory” refers to a machine-readable medium 847 able to store data temporarily or permanently and may be taken to include, but not be limited to, random-access memory (RAM), read-only memory (ROM), buffer memory, flash memory, and cache memory. While the machine-readable medium 847 is shown, in an example embodiment, to be a single medium, the term “machine-readable medium” should be taken to include a single medium or multiple media (e.g., a centralized or distributed database, or associated caches and servers) able to store the instructions 825. The term “machine-readable medium” shall also be taken to include any medium, or combination of multiple media, that is capable of storing instructions (e.g., instructions 825) for execution by a machine e.g., machine 800), such that the instructions 825, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 850 may include a wide variety of components to receive input, provide and/or produce output, transmit information, exchange information, capture measurements, and so on. It will be appreciated that the I/O components 850 may include many other components that are not shown in FIG. 8. In various example embodiments, the I/O components 850 may include output components 852 and/or input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 854 may include alphanumeric input components e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instruments), tactile input components (e.g., a physical button, a touch screen that provides location and force of touches or touch gestures, and/or other tactile input components), audio input components (e.g., a microphone), and the like.

In further example embodiments, the I/O components 850 may include biometric components 856, motion components 858, environmental components 860, and/or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), acoustic sensor components (e.g., one or more microphones that detect background noise), temperature sensor components (e.g., one or more thermometers that detect ambient temperature), humidity sensor components, pressure sensor components (e.g., barometer), proximity sensor components (e.g., infrared sensors that detect nearby objects), and/or other components that may provide indications, measurements, and/or signals corresponding to a surrounding physical environment. The position components 862 may include location sensor components (e.g., a Global Position System (GPS) receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 and/or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 870 may be another machine 800 and/or any of a wide variety of peripheral devices (e.g., a peripheral device coupled via a USB).

Moreover, the communication components 864 may detect identifiers and/or include components operable to detect identifiers. For example, the communication components 864 may include radio frequency identification (RFID) tag reader components, NFC smart tag detection components, optical reader components (e.g., an optical sensor to detect one-dimensional bar codes such as Universal Product Code (UPC) bar codes, multi-dimensional bar codes such as a Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In addition, a variety of information may be derived via the communication components 864, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 880 may be an ad hoc network, an intranet, an extranet, a virtual private network (VPN), a LAN, a wireless LAN (WLAN), a WAN, a wireless WAN (WWAN), a MAN, the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 825 may be transmitted and/or received over the network 880 using a transmission medium via a network interface device (e.g., a network interface component included in the communication components 864) and utilizing any one of a number of well-known transfer protocols (e.g., HTTP). Similarly, the instructions 825 may be transmitted and/or received using a transmission medium via the coupling 872 (e.g., a peer-to-peer coupling) to the devices 870. The term “transmission medium” shall be taken to include any intangible medium that is capable of storing, encoding, or carrying the instructions 825 for execution by the machine 800, and includes digital or analog communications signals or other intangible media to facilitate communication of such software 700,

Furthermore, the machine-readable medium 847 is non-transitory (in other words, not having any transitory signals) in that it does not embody a propagating signal. However, labeling the machine-readable medium 847 as “non-transitory” should not be construed to mean that the medium is incapable of movement; the medium should be considered as being transportable from one physical location to another. Additionally, since the machine-readable medium 847 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A computer-implemented method using at least one computer processor, the method comprising:
receiving a request for recommended courses, wherein the request includes a skill of interest;
accessing a plurality of course records to determine whether a sufficient number of courses that teach the skill of interest are available;
in accordance with a determination that a sufficient number of courses that teach the skill of interest are not available:
accessing a plurality of skill records representing a plurality of skills other than the skill of interest;
generating skill attribute vectors for the skill of interest and the plurality of skills other than the skill of interest;
calculating a distance score between the skill attribute vectors associated with the plurality of skills other than the skill of interest and a skill attribute vector associated with the skill of interest;
ranking the plurality of skills other than the skill of interest based on the distance score associated with their respective skill attribute vectors;
selecting a skill based on the rankings;
identifying at least one course that teaches the selected skill; and
transmitting a course recommendation for the identified course to a client system for presentation.

2. The method of claim 1, further comprising:
for the plurality of skills stored in the database at a server system:
generating a skill attribute vector for each skill in the plurality of skills; and
using the generated skill attribute vectors, grouping the plurality of skills into a plurality of skill groups.

3. The method of claim 2, wherein grouping the plurality of skills into a plurality of skill groups further comprises:
selecting a plurality of skill attribute vectors as group central points;
for a particular skill attribute vector associated with a skill:
calculating a distance between the particular skill attribute vector and a plurality of group central points;
selecting, based on the calculated distance, a skill group with a group central point closest to the particular skill attribute vector; and
grouping the particular skill attribute vector into the selected skill group.

4. The method of claim 3, further comprising:
recalculating the group central point of the selected skill group.

5. The method of claim 3 further comprising:
grouping small skill groups into larger skill groups to create a skill group hierarchy.

6. The method of claim wherein determining whether a sufficient number of courses that teach the skill of interest are available comprises:
accessing metadata for a plurality of courses, the metadata including a list of skills taught by each course; and
identifying whether the metadata for the plurality of courses includes the skill of interest.

7. The method of claim 6, further comprising:
counting a number of courses with metadata that lists the skill of interest;
determining whether the counted number of courses exceeds a requested number of course recommendations; and
in accordance with a determination that the counted number of courses does not exceed the requested number of course recommendations, determining that a sufficient number of courses that teach the skill of interest are not available.

8. A system comprising:
a computer-readable memory storing computer-executable instructions that, when executed by one or more hardware processors, configure the system to perform a plurality of operations, the operations comprising:
receiving a request for recommended courses, wherein the request includes a skill of interest;
accessing a plurality of course records to determine whether a sufficient number of courses that teach the skill of interest are available;
in accordance with a determination that a sufficient number of courses that teach the skill of interest are not available:
accessing a plurality of skill records representing a plurality of skills other than the skill of interest;
generating skill attribute vectors for the skill of interest and the plurality of skills other than the skill of interest;
calculating a distance score between the skill attribute vectors associated with the plurality of skills other than the skill of interest and a skill attribute vector associated with the skill of interest;
ranking the plurality of skills other than the skill of interest based on the distance score associated with their respective skill attribute vectors;
selecting a skill based on the rankings;
identifying at least one course that teaches the selected skill; and
transmitting a course recommendation for the identified course to a client system for presentation.

9. The system of claim 8, further including operations comprising:
for the plurality of skills stored in the database at a server system:
generating a skill attribute vector for each skill in the plurality of skills; and
using the generated skill attribute vectors, grouping plurality of skills into a plurality of skill groups.

10. The system of claim 9, wherein the operations for grouping the plurality of skills into a plurality of skill groups further comprise operations for:
selecting a plurality of skill attribute vectors as group central points;
for a particular skill attribute vector associated with a skill:
calculating a distance between the particular skill attribute vector and a plurality of group central points;
selecting, based on the calculated distance, a skill group with a group central point closest to the particular skill attribute vector; and
grouping the particular skill attribute vector into the selected skill grog

11. The system of claim 10, further including operations comprising:
recalculating the group central point of the selected skill group.

12. The system of claim 10, further including operations comprising:
grouping small skill groups into larger skill groups to create a skill group hierarchy.

13. The system of claim 8, wherein operations for determining whether a sufficient number of courses that teach the skill of interest are available further comprise operations for:
accessing metadata for a plurality of courses, the metadata including a list of skills taught by each course; and
identifying whether the metadata for the plurality of courses includes the skill of interest.

14. The system of claim 13, further including operations comprising:
counting a number of courses with metadata that lists the skill of interest;
determining whether the counted number of courses exceeds a requested number of course recommendations; and
in accordance with a determination that the counted number of courses does not exceed the requested number of course recommendations, determining that a sufficient number of courses that teach the skill of interest are not available,

15. A non-transitory computer-readable storage medium storing instructions that, when executed by the one or more processors of a machine, cause the machine to perform operations comprising:
receiving a request for recommended courses, wherein the request includes a skill of interest;
accessing a plurality of course records to determine whether a sufficient number of courses that teach the skill of interest are available;
in accordance with a determination that a sufficient number of courses that teach the skill of interest are not available:
accessing a plurality of skill records representing a plurality of skills other than the skill of interest;
generating skill attribute vectors for the skill of interest and the plurality of skills other than the skill of interest;
calculating a distance score between the skill attribute vectors associated with the plurality of skills other than the skill of interest and a skill attribute vector associated with the skill of interest;
ranking the plurality of skills other than the skill of interest based on the distance score associated with their respective skill attribute vectors;
selecting a skill based on the rankings;
identifying at least one course that teaches the selected skill; and
transmitting a course recommendation for the identified course to a client system for presentation.

16. The non-transitory computer-readable storage medium of claim 15, further including operations comprising:
for the plurality of skills stored in the database at a server system:
generating a skill attribute vector for each skill in the plurality of skills; and
using the generated skill attribute vectors, grouping the plurality of skills into a plurality of skill groups.

17. The non-transitory computer-readable storage medium of claim 16, wherein the operations for grouping the plurality of skills into a plurality of skill groups further comprise operations for:
selecting a plurality of skill attribute vectors as group central points;
for a particular skill attribute vector associated with a skill:
calculating a distance between the particular skill attribute vector and a plurality of group central points;
selecting, based on the calculated distance, a skill group with a group central point closest to the particular skill attribute vector; and
grouping the particular skill attribute vector into the selected skill group.

18. The non-transitory computer-readable storage medium of claim 17, further including operations comprising:
recalculating the group central point of the selected skill group.

19. The non-transitory computer-readable storage medium of claim 17, further including operations comprising:
grouping small skill groups into larger skill groups to create a skill group hierarchy.

20. The non-transitory computer-readable storage medium of claim 15, wherein operations for determining whether a sufficient number of courses that teach the skill of interest are available further comprise operations for:
accessing metadata for a plurality of courses, the metadata including a list of skills taught by each course; and
identifying whether the metadata for the plurality of courses includes the skill of interest.
